(19) United States
(12) Patent Application Publication
(10) Pub. No.: US 2019/0012565 A1
(43) Pub. Date: Jan. 10, 2019

(54) IMAGE PROCESSING APPARATUS AND METHOD OF CONTROLLING THE SAME

(71) Applicant: CANON KABUSHIKI KAISHA, Tokyo (JP)

(72) Inventor: Masaaki Kobayashi, Chofu-shi (JP)

(21) Appl. No.: 16/025,336

(22) Filed: Jul. 2, 2018

(30) Foreign Application Priority Data
Jul. 4, 2017 (JP) 2017-131487

(51) Int. Cl. G06K 9/62; G06K 9/46

(52) U.S. Cl. CPC G06K 9/6202; G06K 9/4609

(57) ABSTRACT

In order to reduce a processing load in a feature amount calculation for an image, an image processing apparatus operable to derive a feature amount of at least one pixel in an input image, the apparatus comprises: a comparison unit configured to execute a comparison process for comparing pixel values of two pixels included in the input image in the vicinity of a pixel of interest in the input image; and a derivation unit configured to derive a feature amount of the pixel of interest based on a result of a plurality of comparison processes by the comparison unit, at least one of target pixels of the comparison processing by the comparison unit is used in two or more comparison processes.

### BACKGROUND OF THE INVENTION

### Field of the Invention

The present invention relates to a technique for calculating a feature amount of an image.

### Description of the Related Art

In recent years, the importance of techniques for associating respective pixels between images has been increasing. Association is the relationship between a pixel of a base image and a pixel of a reference image that is treated as the same, and can be represented by coordinates of two points. In the case where a stereo or multi-viewpoint image is inputted, because it is possible to calculate the depth of a subject from a correspondence relation of pixels, application to three-dimensional image processing is also possible. In addition, in the case of input of images continuously captured (a moving image), if the correspondence relation is represented as relative coordinates, this becomes a motion vector. By using a motion vector for each pixel (hereinafter, an optical flow), moving body tracking, image stabilization of a moving image, and the like are possible. Association of a pixel of interest is performed by setting a patch centered on the pixel of interest, setting patches centered on a plurality of reference candidate pixels, calculating correlation (degree of similarity) for each patch, and setting the reference candidate pixel with the highest correlation as the reference pixel. There are largely two methods for calculating correlation for patches.

In one method referred to as template matching, a sum of squares or a sum of absolute values for the differences between pixel values of two patches is calculated. These are respectively referred to as SAD (Sum of Absolute Difference) or SSD (Sum of Squared Difference), and the smaller the accumulated value the higher the correlation.

In another method, the difference in pixel values for two points in a patch is calculated, a multi-dimensional vector that collects a plurality of differences in pixel values is calculated as a feature amount, and feature amounts are compared. The norm of the difference between a multi-dimensional vector corresponding to the pixel of interest and a multi-dimensional vector corresponding to a reference candidate pixel is calculated, and it is deemed that the smaller the norm the higher the correlation. Specifically, there are algorithms such as SIFT (Scale-Invariant Feature Transform) or BRIEF (Binary Robust Independent Elementary Features). Details of BRIEF are recited in “BRIEF: Binary Robust Independent Elementary Features, Computer Vision-ECCV 2010, Volume 6314 of the series Lecture Notes in Computer Science, pp 778-792”. A SIFT feature amount is represented by a multi-value multi-dimensional vector. In contrast, a BRIEF feature amount is represented by a bit sequence that is a set of bits, and is also referred to as a binary feature amount. The norm of this bit sequence is also referred to as a Hamming distance in particular, and is obtained by taking the XOR (exclusive OR) of two bit sequences and counting the number of “1”s. A method for obtaining correlation by calculating a Hamming distance typified by BRIEF has a very small calculation load because the correlation calculation can be performed by a bit computation. Accordingly, it is suitable for both implementation by hardware (an LSI or the like), or implementation by software.

However, to calculate the feature amount from the difference of pixel values of pixels in a patch requires obtaining the pixel values of the image. To obtain the pixel values of an image loaded into memory requires calculation of the addresses where the pixel values are stored, and memory access to the addresses. Accordingly, an increase in an amount of processing occurs in accordance with a number of pixels to reference.

### SUMMARY OF THE INVENTION

According to one aspect of the present invention, an image processing apparatus operable to derive a feature amount of at least one pixel in an input image, the apparatus comprises: a comparison unit configured to execute a comparison process for comparing pixel values of two pixels included in the input image in the vicinity of a pixel of interest in the input image; and a derivation unit configured to derive a feature amount of the pixel of interest based on a result of a plurality of comparison processes by the comparison unit, wherein at least one of target pixels of the comparison processing by the comparison unit is used in two or more comparison processes.

The present invention provides a technique that allows a processing load in a feature amount calculation for an image to be reduced.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating a configuration of an image processing apparatus according to a first embodiment.

FIG. 2 is a flowchart illustrating generation of a feature amount in the first embodiment.

FIG. 3 is a view that explanatorily illustrates a comparison pattern for generation of a feature amount.

FIG. 4 is a flowchart illustrating generation of a feature amount in a second embodiment.

FIGS. 5A and 5B are block diagrams illustrating configurations of an image processing apparatus according to a third embodiment.

FIGS. 6A and 6B are a view that explanatorily illustrates a table for specifying relative coordinates for generating a feature amount.

FIG. 7 is a view that explanatorily illustrates an index defined by a 15×15 region.

FIG. 8 is a flowchart illustrating generation of a feature amount in a fourth embodiment.

### DESCRIPTION OF THE EMBODIMENTS

Explanation is given in detail below, with reference to the drawings, of examples of embodiments of the invention. Note, the following embodiments are only examples and are not intended to limit the scope of present invention.

### First Embodiment

As a first embodiment of an image processing apparatus according to the present invention, description is given below of an apparatus for deriving a binary feature amount of an image, as an example. Specifically, with reference to coordinates of a pixel of interest, a plurality of relative pixel positions (coordinates) to which an order (index) is added are decided in advance. The binary feature amount is then derived based on pixel values of pixels at the relative pixel position of two consecutive indexes.

<Assumptions>

For the description of the first embodiment, description is given regarding matters that are assumed. In the following description, an image is an 8-bit integer (256 tone) monochrome image. In addition, description is given for a method for calculating the binary feature amount of a pixel of interest, but it is assumed that a pixel of interest is a target pixel when sequentially scanning pixels of an image, or a target pixel when sequentially scanning a plurality of feature points that are a result of performing feature point detection on an image. Description regarding how a pixel of interest is selected is omitted, but any method can be used. The obtained feature amount is compared (in other words a Hamming distance is calculated) with the feature amount of a pixel obtained from another image that is temporally contiguous. Pixels having the shortest Hamming distance therebetween are matched, and by obtaining the relative coordinates of the matched pixel, it is possible to obtain the motion of a pixel. Accordingly, application to object recognition or the like is possible.

<Apparatus Configuration>

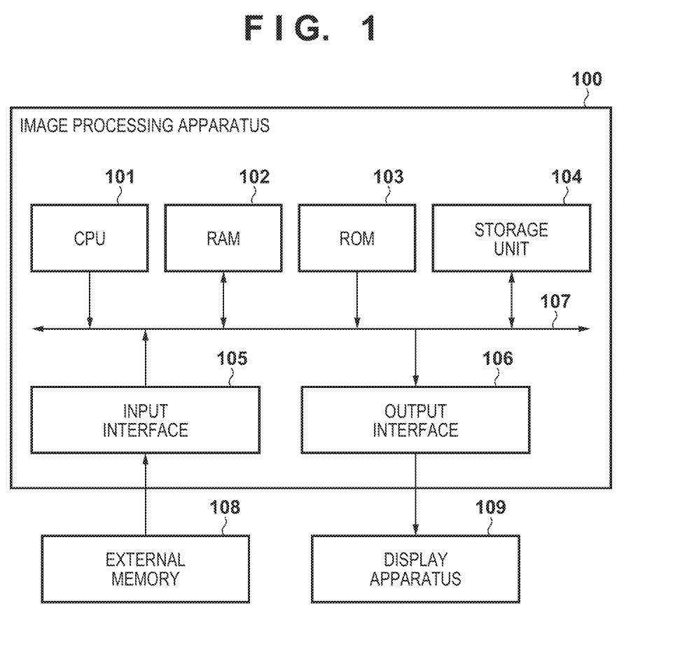

FIG. 1 is a block diagram illustrating a configuration of an image processing apparatus according to a first embodiment.

An image processing apparatus 100 has a CPU 101, a Ram 102, a ROM 103, and a storage unit 104 such as a hard disk drive (HDD). In addition, the image processing apparatus 100 has an input interface (I/F) 105 for input of data from an external memory 108 which is a storage unit of an external apparatus, and an output interface (I/F) 106 for outputting data to a display device 109. Units of the image processing apparatus 100 are communicably connected to one another via a bus 107.

The CPU 101 is a processor that executes a program read into the RAM 102. The Ram 102 is a work memory and temporarily stores data such as an image, a calculation result, or the like. In addition, an execution program is stored in the ROM 103 or the storage unit 104. Unless there is particular description, the CPU 101 inputs and outputs data via the bus 107. The storage unit 104 is an apparatus for recording execution programs and data such as images or processing results. When a program is executed, the program and an image is read from the storage unit 104 into the Ram 102, and a processing result is written from the memory 102 to the storage unit 104.

<Operation of Apparatus>

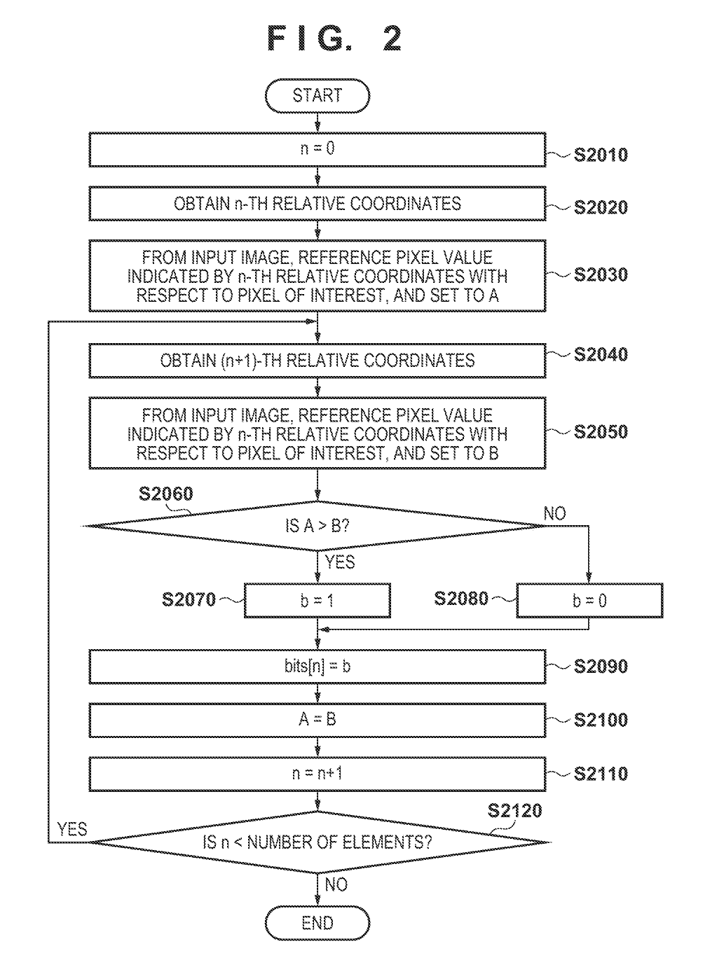

FIG. 2 is a flowchart illustrating generation of a feature amount in the first embodiment. In the description of the flowchart below, symbols for each step are indicated by the letter S. Here, a 64-bit binary feature amount is generated for a pixel of interest. Note that, in the present embodiment, description is given by assuming that processing is performed in the order indicated by arrow symbols in the figure, but other loop processing or another order for processing may be used if there is a flow that generates the same result.

In step S2010, the CPU 101 initializes n to “0”. n is a control variable for a loop that is described below. In step S2020, the CPU 101 obtains the n-th relative coordinate data. The relative coordinate data is assumed to represent horizontal and vertical coordinate values as (xₙ, yₙ). Here, it is assumed that xₙ and yti are represented by values in the range of −15 through 15. In addition, it is assumed that the relative coordinate data includes 65 pieces of coordinate data, and n has values of 0 through 64. The relative coordinates may be prepared immediately prior to the feature amount calculation processing, may be read by calling something stored in the HDD in advance into the memory, and may be generated immediately before execution of the processing indicated in FIG. 2.

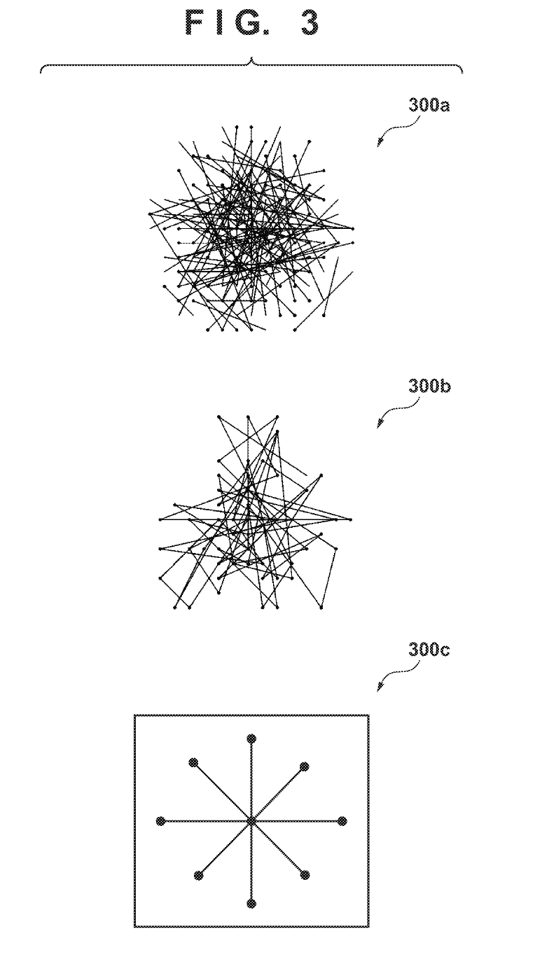

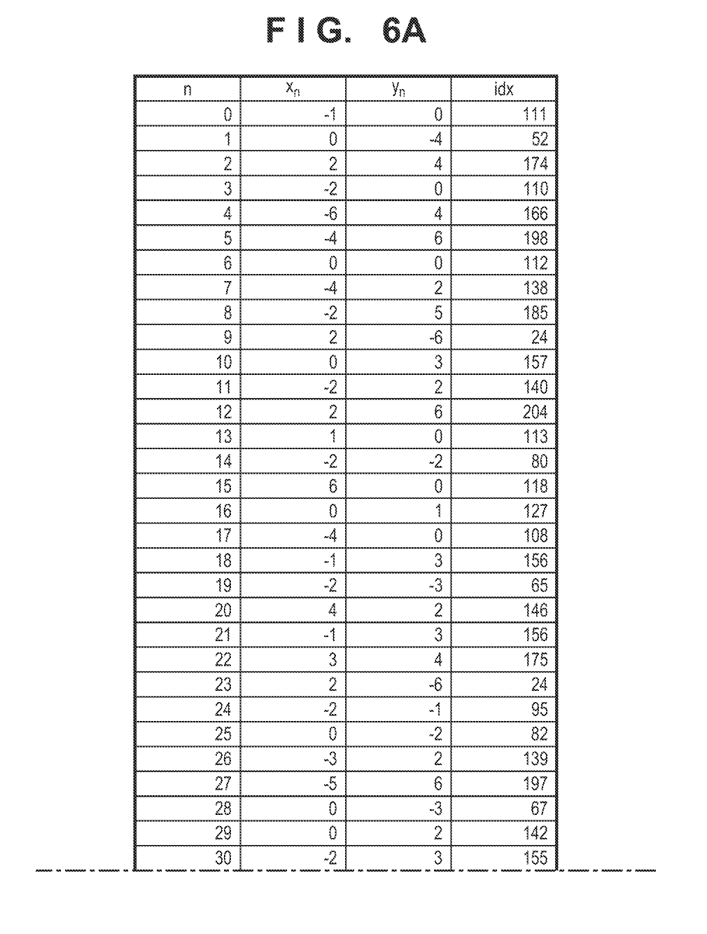

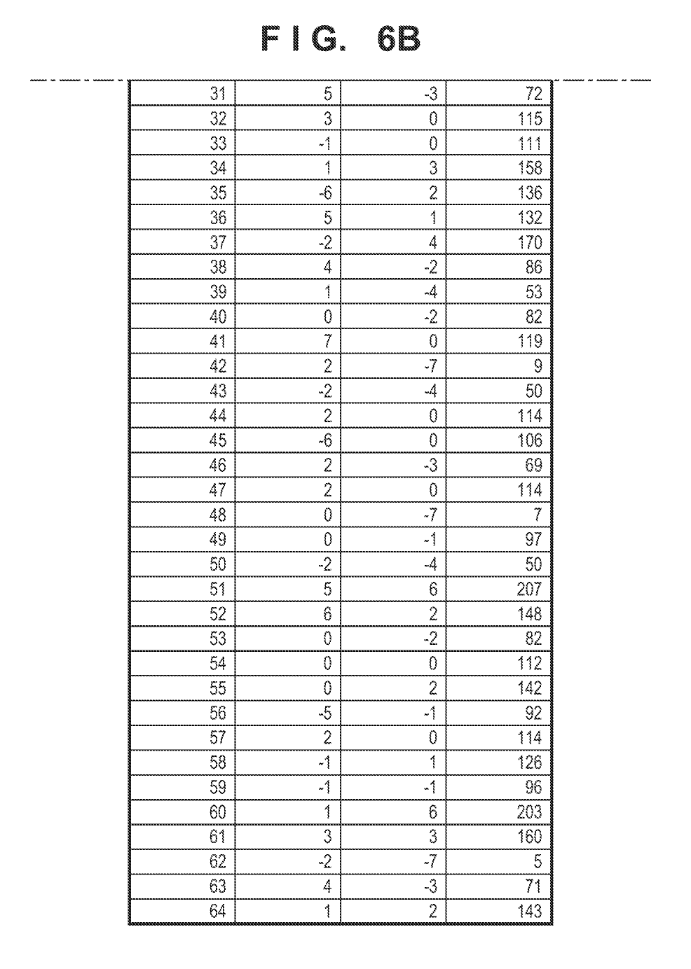

FIGS. 6A and 6B are a view that explanatorily illustrates a table for specifying relative coordinates for generating a feature amount. The table associates the index “n” for the number of loops, the coordinate information “xₙ” and “yₙ” for the relative coordinate, and an index value “idx” that is described later. Description is given later with reference to FIG. 3 of the characteristics of relative coordinates defined by the table.

In step S2030, the CPU 101 refers to (obtains the pixel value) the pixel value of a pixel indicated by the n-th relative coordinates with respect to the pixel of interest from the input image, and sets this pixel value as A. When the coordinates of the current pixel of interest are (xₜ, yₜ), the address for the pixel at the coordinates of (xₜ+xₙ, yₜ+yₙ) is calculated, and the pixel value thereof is obtained. Letting the width of the input image be w, and letting the address value in memory of the (0, 0) coordinates be BaseAddr, the pixel value A can be referenced by reading the value at the address value that can be calculated by (yₜ+yₙ)×w(xₜ+xₙ)+BaseAddr.

In step S2040, the CPU 101 references the (n+1)-th relative coordinates (obtains a pixel value). In step S2050, the CPU 101 refers to the pixel value of a pixel indicated by the (n+1)-th relative coordinates with respect to the pixel of interest from the input image, and sets this pixel value as B. This obtains the pixel value for the coordinates (xₜ+yₙ₊₁, yₜ+yₙ₋₁).

In step S2060, the CPU 101 compares A and B, and if A>B is true, the processing transitions to step S2070, and if false, the processing transitions to step S2080. Note that, in the present embodiment, the comparison of “>” is used but there is no limitation to this, and any of “<”, “≥”, and “≤” may be used.

In step S2070, the CPU 101 sets b=1. In step S2080, the CPU 101 sets b=0. In step S2090, the CPU 101 sets bits[n]=b. The elements of bits are assumed to be bits that can be accessed by an index operation using [ ]. Although details are described later, by incrementing n and sequentially substituting its value into bits[n], a bit sequence is generated.

In step S2100, the CPU 101 sets A=B. In the loop processing of step S2040 through step S2120, a value for subsequent processing is stored in advance. In step S2110, the CPU 101 sets n=n+1 (increments n). In step S2120, the CPU 101 determines whether n<the number of elements, and when the determination result is true the processing proceeds to step S2040, and when it is false the processing ends. The number of elements is the number of bits to generate, in other words the bit length of the binary feature amount to generate (M bits long), and here M=64. Step S2040 through step S2120 is a loop structure where the processing is repeated a predetermined number of times (executed M times). By this processing, a 64-bit bit sequence is obtained as a binary feature amount.

<Description of Relative Coordinate Data>

FIG. 3 is a view that explanatorily illustrates comparison patterns for generation of a feature amount. Specifically, the relative coordinates of a plurality (N) of pixels arranged as references for a pixel of interest which has predetermined coordinates are explanatorily illustrated. A pattern 300a is an arrangement pattern of line segments in BRIEF, which is a conventional technique. A pattern 300b is an arrangement pattern of line segments in the first embodiment.

BRIEF, which is a conventional technique, generates a bit sequence by referring to pixel values while holding relative coordinate data for two points for two points to compare, in other words each independent line segment. In other words, BRIEF uses an arrangement pattern of a plurality of discrete line segments as illustrated by the pattern 300a. In this case, a 64-bit binary feature amount is generated from 128 pieces of relative coordinate data.

Meanwhile, in the first embodiment, a plurality of pixels designated by a list of pieces of relative coordinate data are consecutively accessed, a large/small comparison is made for the pixel values of a pixel currently accessed and a pixel accessed one time previous, and the comparison result is set as a bit value. The generated bit values are concatenated into 64 (M) bits to generate a binary feature amount. In other words, in the first embodiment, an arrangement pattern of a plurality of consecutive line segments as illustrated by the pattern 300b is used. In other words, the plurality of line segments are arranged as if they were drawn with a single stroke. In this case, a 64-bit binary feature amount is generated from 65 pieces of relative coordinate data. In other words, in the first embodiment, the number of pieces of relative coordinate data (number of pixel references) is approximately halved in comparison to BRIEF.

As described by step S2030 described above, a pixel reference is an address calculation, and in other words accompanies a multiplication, and so a calculation cost is very high. Accordingly, a reduction in the number of pixel references greatly contributes to the reduction of processing load or processing time. Note that, in the description given above, description was given assuming that 65 points of data are held, but data for the 65th point (n=64) may be made the same as the first point (n=0).

Next, description is given regarding characteristics of relative coordinate data. As described above, xₙ and yₙ are decided in accordance with random numbers in the range of −15 to 15, but it is set so that line segments do not overlap. In other words, the relative coordinates of N pixels are configured so that line segments configured by the coordinates of an n-th pixel and coordinates of an (n+1)-th pixel do not match for any given n. The table shown in FIGS. 6A and 6B is an example of a list of relative coordinate data having the following restrictions.

Two consecutive relative coordinates are set separated by at least one pixel or more. In other words, for any given n, √{(xₙ−xₙ₊₁)²+(yₙ−yₙ₊₁)²}≥1 is satisfied. However, being separated by two pixels or more increases identification capability which is described later.

For line segments having the same start point, the end points are separated by at least one pixel or more. In other words, for any n, if xₙ=xₙ₊ₛ and yn=yₙ₊ₛ, then √{(xₙ₊₁−xₙ₊ₛ₊₁)²+(yₙ₊₁−yₙ₊ₛ₊₁)²}≥1 is satisfied. Here s is a non-zero integer. However, being separated by two pixels or more increases identification capability which is described later.

A line segment that is only a reverse rotation of the start point and an end point of a line segment is not permitted. In other words, for any n, in the case where xₙ=xₙ₊ₛ₊₁ and yₙ=yₙ₊ₛ₊₁, at least one of xₙ₊₁≠xₙ₊ₛ and yₙ₊₁≠yₙ₊ₛ is satisfied.

An adjacent pixel is likely to have a similar value due to optical blurring, smoothing from image processing, or the like. In other words, with a certain line segment there is a trend for a line segment having an adjacent start point and end point to have a similar comparison result, and it is unlikely for a difference to occur when comparing feature amounts. In other words, it can be said that an identification capability is low and the value of the information is low. Accordingly, in the present embodiment, by providing restrictions on the arrangement of relative coordinates, it is possible to generate a bit sequence, in other words a feature amount, having high identification capability and high value as information. In the case of calculating feature amounts for two points and calculating a Hamming distance, it is possible to obtain correlation of images.

In the description described above, description is given assuming usage of a bit sequence, as a feature amount, generated based on consecutive line segments (the pattern 300b), but additional information may be added to the generated bit sequence. For example, configuration may be taken to add a bit sequence created by, as with the pattern 300c, taking the pixel of interest (a center coordinate) as a start point, taking points arranged concentrically as end points, arranging line segments, and comparing the pixel value of the start point with the pixel values of the end points. In this example it is possible to generate an 8-bit bit sequence, and, if concatenated to the generated 64-bit binary feature amount, means that a 72-bit binary feature amount is generated. There are many cases where the center pixel is a pixel that most represents features of the pixel of interest, and generating a bit sequence that predominantly uses the pixel value thereof leads to improving the identification capability of the feature amount. In addition, in step S2030, a pixel value is directly referenced, but configuration may such that the pixel values of an image resulting from performing a 3×3 average filter are obtained.

By virtue of the first embodiment as described above, the start point and end point for each of a plurality of consecutive line segments are used to refer to successive pixel values and generate a binary feature amount. By this configuration it is possible to reduce the number of references to pixels necessary for generation of a binary feature amount, and it is possible to reduce a processing load and processing time.

Note that, in the present embodiment, pixel values are consecutively compared to generate a binary feature amount. Accordingly, by analyzing the binary feature amount, it is possible to obtain the characteristics of image components of a pixel of interest and a peripheral region thereof. In the case where a ratio for the number of 0 in the binary feature amount is 100%, because pixel values are continuously compared, it is guaranteed that the series of pixel values are the same. Although the pixels to compare are sampled, this indicates that the probability that the pixel of interest and the pixels of the peripheral region thereof are uniform is sufficiently high. It can be said that, if the pixels are uniform, in the case where a Hamming distance is calculated and matching is performed, the values will be the same and the reliability of a matching result will be low, and if the pixels are not uniform then the reliability of the matching result will be high. Accordingly, a reliability r of a feature amount that can be calculated from 0 of a binary feature amount can be calculated from the following equation. Note that a BRIEF feature amount has no meaning for a ratio of 0 and 1, and thus this characteristic is a characteristic that is unique to the feature amount.

$$r = 1 - \frac{{\sum }_{m = 0}^{M - 1} bits [ m ]}{M}$$

In addition, in the first embodiment, the feature amount is generated by comparing, in order, two pixels whose indexes in a list of relative coordinate data (FIGS. 6A and 6B) are consecutive, for pixel values of N pixels. In other words, in the n-th comparison, a comparison is made between the n-th pixel and the (n+1)-th pixel. However, there is no need for indexes to be consecutive for two pixels that are compared, and it is sufficient if configuration is such that one of two pixels compared in a current loop is one of two pixels compared in the preceding loop. In other words, in the n-th comparison, it is sufficient if the pixel value of a {c+(n−1)×k₁}-th pixel is compared with the pixel value of {(c+n×k₁) mod N}-th pixel. Here c is a value that corresponds to the index (offset) of the first pixel compared against in the first loop, and is an integer. Note that k₁ is a positive integer, and configuration may be taken to have k₁ be a fixed value in the loop calculations of step S4040 through step S4120, and configuration may be taken to set so that k₁ changes. When k₁ is a fixed value, two pixels that are separated by k₁ are compared in order.

For example, in a case where N=8 (a total of eight pixels: a zero-th to a seventh) k₁=3 (a fixed value), and a 6-bit bit sequence is generated, a comparison is performed between pixel values of the following two pixels in respective loops. Note that mod indicates a remainder calculation.

First loop: zero-th pixel and third pixel

Second loop: third pixel and sixth pixel

Third loop: sixth pixel and first (=(6+3) mod 8) pixel

Fourth loop: first pixel and fourth pixel

Fifth loop: fourth pixel and seventh pixel

Sixth loop: seventh pixel and second (=(7+3) mod 8) pixel

In this way, by comparing the pixel value of one of two pixels compared in a preceding loop with the pixel value of a pixel newly obtained in the current loop (step S2040) to generate one bit value, it is possible to reduce the number of references to pixels. In other words, by drawing in a single stroke line segments defined by the two pixels compared in each loop, as illustrated by the pattern 300b, it is possible to reduce the number of pixel references.

### Second Embodiment

In the second embodiment, description is given regarding an example where a 64-bit feature amount is generated for a pixel of interest, based on the pixel values of 34 relative coordinates set for the pixel of interest. Specifically, with reference to coordinates of a pixel of interest, a plurality of relative pixel positions (coordinates) to which an order (index) is given are decided in advance. The binary feature amount is then derived based on pixel values of pixels at the relative pixel position of two indexes that are one apart. Note that because an apparatus configuration is similar to that of the first embodiment (FIG. 1), description thereof is omitted.

<Apparatus Operation>

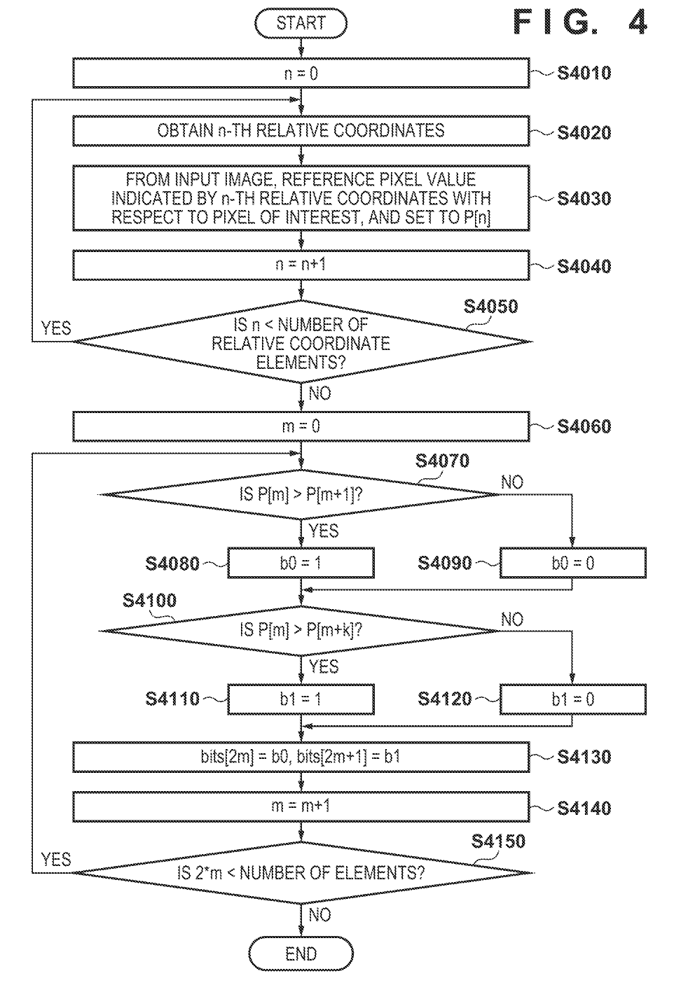

FIG. 4 is a flowchart illustrating generation of a feature amount in the second embodiment. As described above, generating a 64-bit feature amount from 34 pieces of relative coordinate data is envisioned here. In addition, in the following description, description is only given for portions differing from the first embodiment (FIG. 2).

In step S4010, the CPU 101 sets n=0. n is a control variable for loop processing that is described below. In step S4020, the CPU 101 obtains the n-th relative coordinate data. The relative coordinate data is assumed to represent horizontal and vertical coordinate values as (xₙ, yₙ). In the present embodiment, it is assumed that xₙ and yₙ are each represented by a value in the range of −15 through 15. In addition, it is assumed that the relative coordinate data has 34 elements, and n has values of 0 through 33.

In step S4030, the CPU 101 refers to the pixel value indicated by the n-th relative coordinates with respect to the pixel of interest from the input image, and sets this pixel value as P[n]. In other words, the pixel value of (xₜ+xₙ, yₜ+yₙ) is obtained for the input image.

In step S4040, the CPU 101 sets n=n+1. In step S4050, the CPU 101 determines whether n<the number of elements for relative coordinates. In the present embodiment, the number of elements for relative coordinates is “34” as described above. In the case where the determination result is true, the processing transitions to step S4020. In the case where the determination result is false, the processing transitions to step S4060. Step S4020 through step S4050 is loop processing controlled by n, and an array of consecutive pixel values is created.

In step S4060, the CPU 101 sets m=0. m is a control variable for a loop that is described below. In step S4070, the CPU 101 determines whether P[m]>P[m+1]. If the determination result is true the processing transitions to step S4080, and if false the processing transitions to step S4090. In step S4080, the CPU 101 sets b0=1. Subsequently the processing transitions to 4100. In step S4090, the CPU 101 sets b0=0. Subsequently the processing transitions to step S4100.

In step S4100, the CPU 101 determines whether P[m]>P[m+k]. In the present embodiment, it is assumed that k=2. If the determination result is true the processing transitions to step S4110, and if false the processing transitions to step S4120. In step S4110, the CPU 101 sets b1=1. Subsequently the processing transitions to step S4130. In step S4120, the CPU 101 sets b1=0. Subsequently the processing transitions to step S4130.

In step S4130, the CPU 101 sets bits[2m]=b0, and bits[2m+1]=b1. It can also be said that this is processing for concatenating two generated bits.

In step S4140, the CPU 101 sets m =m+1. In step S4150, the CPU 101 determines whether 2×m+1<the number of elements. In the case where the determination result is true, the processing transitions to step S4070. If false the processing ends. As described above, in the present embodiment the number of elements is “64”. Step S4070 through step S4140 is the loop processing where m is the control variable, a bit sequence of two bits in length is created by the first loop processing, and a bit sequence of 64 bits in length (2M bits in length) is created by M overall loops (here M=32).

By virtue of the second embodiment as described above, it is possible to generate a binary feature amount by a number of pixel references that is approximately half in comparison to in the first embodiment.

Note that, although description was given above for an example where two bits are created from points indicated by two pieces of consecutive relative coordinate data, but there is no limitation to this. Configuration may be taken to compare three or more points such as p[m+1], p[m+2], and p[m+3] with respect to p[m] which is a reference. However, because the identification capability of the generated feature amount will be reduced when the number of relative coordinate elements are reduced too much, application of this may be made when there is a sufficiently large number of bits in the bit sequence.

In addition, in the above description, the configuration is in accordance with a comparison between adjacent pixels (k₁=1) and a comparison between pixels that are one pixel apart (k₂=2), but there is no limitation to this. k₁ and k₂ may be any number. For example, configuration may be taken such that, when the pattern of consecutive line segments is set to a hexadecagon (in other words, N=16), both of k₁=3 and k₂=9 are set, and two generated bit sequences are concatenated to generate one bit sequence.

Furthermore, although there is a two-stage configuration with the loop of step S4020 through step S4050 and the loop of step S4070 through step S4140, there is no necessity to have a two-stage configuration. Configuration may be taken to generate a bit immediately after referencing a pixel value. In such a case, there ceases to be a need for the array P to have a region for holding all of the pixel values.

### Third Embodiment

In the third embodiment, description is given regarding an implementation example for a case of configuring an apparatus for generating a binary feature amount by a hardware circuit.

<Apparatus Configuration>

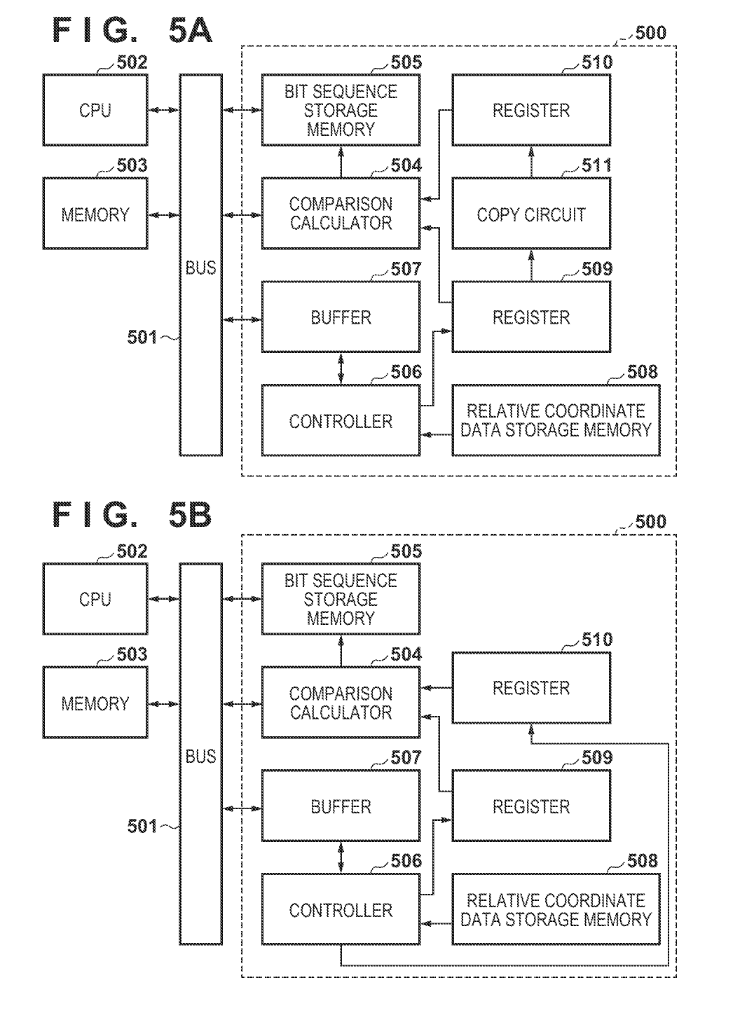

FIGS. 5A and 5B are block diagrams illustrating configurations of an image processing apparatus according to a third embodiment. Description is given below regarding a binary feature amount generation apparatus illustrated by FIG. 5A.

A generation apparatus 500 is controlled by a CPU 502 via a bus 501. A memory 503 is arranged as a work memory in which processing target image data or the like is stored. The generation apparatus 500 has a comparison calculator 504, a bit sequence storage memory 505, a controller 506, a buffer 507, a relative coordinate data storage memory 508, registers 509 and 510, and a copy circuit 511. Note that it is assumed here that the relative coordinate data storage memory 508 stores the relative coordinate data illustrated in FIGS. 6A and 6B. Note that, the generation apparatus 500, the CPU 502, and the memory 503 are illustrated as separate bodies here, but they may be configured integrally.

Below FIG. 5A is used to give a description regarding operations for generating bits one-by-one from the pixel of interest to ultimately generate a 64-bit bit sequence.

The CPU 501 causes pixels of a 15×15 region centered on a pixel of interest, out of image data stored in the memory 503, to be read into the buffer 507. Description is given below regarding an operation for generating the n-th bit (n is from 0 to 63).

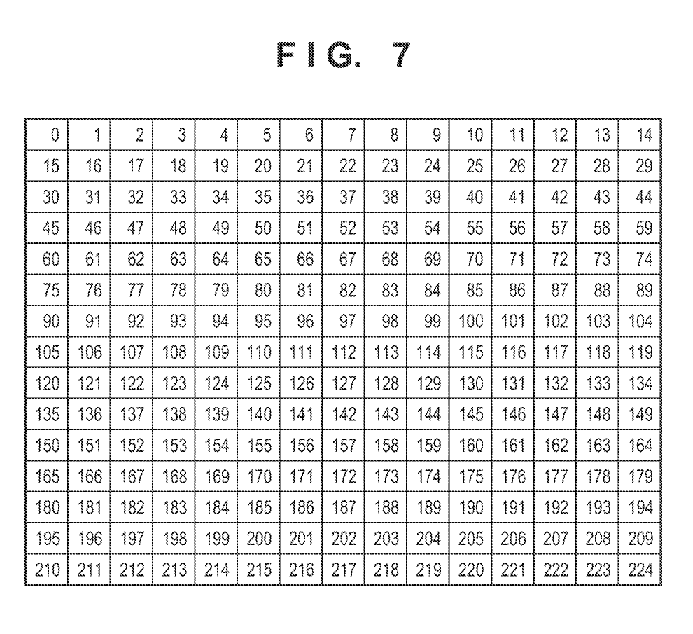

The controller 506 reads the relative coordinate data in order from the relative coordinate data storage memory 508, and stores the pixel value of a corresponding pixel in the register 509. Here, in one operation, the relative coordinate data of FIGS. 6A and 6B for the index value designated by the column for “idx” is referenced in order. Furthermore, the pixel value of a position corresponding to an index map illustrated in FIG. 7 is obtained for the index value. FIG. 7 is a view for describing an index map that has 15×15 regions. Index values of 0 through 224 are allocated to regions corresponding to respective pixels. In other words, the index values illustrated in FIG. 7 are designated in the “idx” column of the relative coordinate data of FIGS. 6A and 6B. In other words, the relative coordinates of the N pixels illustrated in FIGS. 6A and 6B are arranged with respect to a square region illustrated in FIG. 7 that is centered on coordinates of interest and having K pixel sides (here K=15). Note that K is a positive integer that satisfies N<K̂2. The copy circuit 511 copies a pixel value stored in the register 509 and stores it to the register 510.

Subsequently, the controller 506 writes pixel value data corresponding to the next relative coordinate in the relative coordinate data to the register 509. The comparison calculator 504 compares the value of the register 509 (“A” here) and the value of the register 510 (“B” here), and if A>B outputs “1” to the bit sequence storage memory 505, and otherwise outputs “0”. The bit sequence storage memory 505 successively joins inputted bits.

Subsequently, copying of values, reading of pixel value data of the controller 506 and writing to the register 509 by the copy circuit 511, and the comparison calculations and bit outputs by the comparison calculator 504 are sequentially performed, and a bit sequence is generated. When a 64-bit bit sequence is generated, the CPU 501 reads the bit sequence from the bit sequence storage memory and writes it to the memory 503.

The above operations are repeated for each pixel of interest, and a plurality of feature amounts are generated. By such a hardware configuration, it is possible to generate a feature amount similarly to in the first embodiment.

Note that, description was given of an implementation examples in FIG. 5A where the copy circuit 511 is used to copy a value, but there is no limitation to this configuration. For example, a configuration illustrated in FIG. 5B may be taken. In FIG. 5B, the controller 506 performs an operation for alternatingly writing a pixel value to the register 509 and the register 510. Accordingly, the copy circuit 511 is not necessary. Note that, in this case, different bits are generated to those of FIG. 5A when the value of the register 509 (“A” here) and the value of the register 510 (“B” here) are always compared with A>B. However, there is no problem in using this value as a feature amount as long as the feature amount is generated by the same apparatus. Note that, in a case of generating a feature amount that is the same as that in the first embodiment, it is necessary to alternatingly perform “a determination for A>B” and “a determination for B<A” in the comparison calculator 504.

In addition, in the above description, a configuration is given where one comparison calculator generates bits to generate a bit sequence, but there is no limitation to this. Configuration may be taken to have two or more comparison calculators or registers. In such a case, processing for generating bits while referencing pixels is performed in parallel.

By virtue of the third embodiment as described above, it is possible to generate a binary feature amount similar to that of the first embodiment by hardware. Note that, in the above description, description was given regarding a hardware configuration for performing processing equivalent to the first embodiment, but it is also possible to have a hardware configuration for performing processing similar to that of the second embodiment. However, in such a case additional registers are necessary.

### Fourth Embodiment

In the fourth embodiment, description is given regarding a form where a feature amount indicated as an array is generated. In other words, although description was given in the first through third embodiments regarding examples of generating a binary feature amount where one element is represented by one bit value, in the fourth embodiment a feature amount where one element is represented by a plurality of bit values is generated.

<Apparatus Operation>

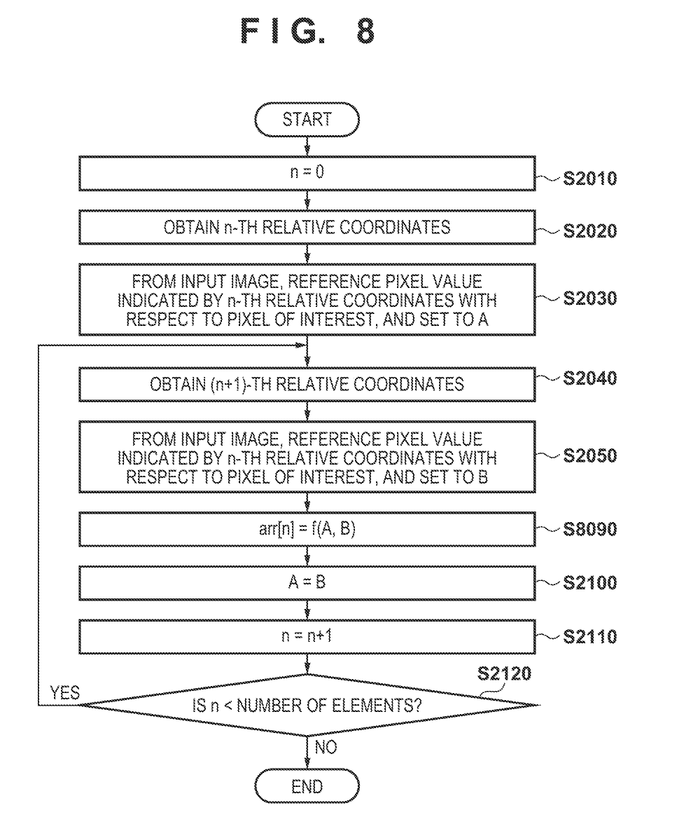

FIG. 8 is a flowchart illustrating generation of a feature amount in the fourth embodiment. Unless there is particular description, it is the same as the operation described in the first embodiment (FIG. 2). Here, the feature amount to ultimately generate (a multi-dimensional vector) is an array represented by arr. In the fourth embodiment 64 elements are held, in other words a 64-dimensional vector. Step S2010 through step S2050 and step S2100 through step S2120 are the same operations for the same symbols of FIG. 2. After the processing of step S2050 is performed, step S8090 is performed.

In step S8090, the CPU 101 calculates a function taking A and B as arguments, and substitutes a result into arr[n]. The function f turns the comparison result for A and B into a numerical value, and for example using the following equation that indicates a difference is possible.

f(a, b)=a−b (1)

Here it is assumed that, because A and B are each an 8-bit value, one element of arr can be represented by an integer of 9 bits or more. An equation to use is not limited to Equation (1), and the following Equation (2) or Equation (3) may be used.

The following Equation (2) is a formula where a calculation result is multiplied by a coefficient so as to fit into “8 bits with a sign”. With Equation (2) it is possible to fit one element of arr into 8 bits.

f(a, b)=127×(a−b)/255 (2)

In addition, configuration may be taken to saturate by applying a coefficient k, as in the following Equation (3), so as to fit within 8 bits with a sign. max(a, b) is a function that returns the larger value out of a and b, and min(a, b) is a function that returns the smaller value out of a and b. The coefficient k may be set to a value proportional to the contrast of an image (for example the standard deviation of an input image). With Equation (3) it is also possible to fit one element of arr into 8 bits.

f(a, b)=min(max(k(a−b), 128), 127) (3)

In this way f can be defined in various ways as long as it is a function for calculating a value that represented a magnitude relationship for A and B. After the processing of step S8090, a transition is made to step S2100. When the flow ends, the feature amount is generated as arr.

By virtue of the fourth embodiment as described above, it is possible to calculate a feature amount where one element is represented by multiple bits. Note that, in the above description, an 8-bit integer (256 tone) image is handled, but there is no limitation to this, and application can be made to an image represented by 16-bit integers or floating-point numbers.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-131487, filed Jul. 4, 2017 which is hereby incorporated by reference herein in its entirety.

What is claimed is:

1. An image processing apparatus operable to derive a feature amount of at least one pixel in an input image, the apparatus comprising:
a comparison unit configured to execute a comparison process for comparing pixel values of two pixels included in the input image in the vicinity of a pixel of interest in the input image; and
a derivation unit configured to derive a feature amount of the pixel of interest based on a result of a plurality of comparison processes by the comparison unit,
wherein at least one of target pixels of the comparison processing by the comparison unit is used in two or more comparison processes.

2. The image processing apparatus according to claim 1, wherein the comparison unit executes the comparison process of the pixel values of two pixels M times to output M comparison results, and wherein the two pixels compared at an n-th time (2≤n≤M) include one of the two pixels compared at an (n−1)-th time.

3. The image processing apparatus according to claim 1, wherein the comparison unit sets at least one pixel that was a target in or before a (n−1)-th comparison process as a target of an n-th comparison process.

4. The image processing apparatus according to claim 1, further comprising a storage unit configured to store a pixel value of each pixel in the input image,
wherein the comparison unit updates one of the two pixels compared in an (n−1)-th comparison process to a pixel value of a new pixel read from the storage unit, and then performs an n-th comparison process.

5. The image processing apparatus according to claim 1, further comprising a storage unit configured to store coordinate information indicating relative coordinates of N pixels arranged based on predetermined coordinates,
wherein the comparison unit decides a pixel to be subject to a comparison process by referencing the coordinate information.

6. The image processing apparatus according to claim 2, wherein the derivation unit derives the feature amount of the pixel of interest by concatenating M results of the comparison process outputted by the comparison unit.

7. The image processing apparatus according to claim 5, wherein the comparison unit, in an n-th comparison, compares a pixel value of a {c+(n−1)×k₁}-th (where c is an integer and k₁ is a positive integer that satisfies {c+(n−1)×k₁}≤N) pixel and a pixel value of a {(c+n×k₁) mod N}-th pixel included in the coordinate information.

8. The image processing apparatus according to claim 7, wherein
the comparison unit outputs, as a result of the comparison process, one bit value indicating larger/smaller for pixel values of two compared pixels, and
the derivation unit derives, as the feature amount of the pixel of interest, a value M bits long obtained by performing bit concatenation of M results of the comparison process outputted by the comparison unit.

9. The image processing apparatus according to claim 2, wherein
the comparison unit outputs, as a result of the comparison process, a plurality of bit values obtained by performing a predetermined calculation with respect to a difference of pixel values of two compared pixels, and
the derivation unit derives, as the feature amount of the pixel of interest, an array obtained by concatenating M results of the comparison process outputted by the comparison unit.

10. The image processing apparatus according to claim 1, further comprising a storage unit configured to store coordinate information indicating relative coordinates of N pixels arranged based on predetermined coordinates,
wherein the comparison unit comprises:
a first comparison unit configured to execute M comparison processes for pixel values of N pixels and output M first comparison results, and
a second comparison unit configured to compare pixel values of two pixels included in the pixels values of the N pixels and output a second comparison result,
wherein the first comparison unit, in an n-th (2≤n≤M) comparison, compares a pixel value of a {c+(n−1)×k₁}-th (here c is an integer and k₁ is a positive integer that satisfies {c+(n−1)×k₁}≤N) pixel and a pixel value of a {(c+n×k₁) mod N}-th pixel included in the coordinate information,
the second comparison unit executes a comparison of pixel values for two pixels M times to output M second comparison results, and in an n-th comparison, compares a pixel value of a {c+(n−1}-th (here k₂ is a positive integer that satisfies k₂≠k₁) pixel and a pixel value of a {(c+n×k₂) mod N}-th pixel included in the coordinate information, and
the derivation unit further concatenates the M second comparison results outputted by the second comparison unit to derive the feature amount of the pixel of interest.

11. The image processing apparatus according to claim 10, wherein
the first comparison unit outputs, as the first comparison result, one bit value indicating larger/smaller for pixel values of two compared pixels, and
the second comparison unit outputs, as the second comparison result, one bit value indicating larger/smaller for pixel values of two compared pixels, and the derivation unit derives, as the feature amount of the pixel of interest, a value 2M bits long obtained by performing a bit concatenation of the M first comparison results outputted by the first comparison unit and the M second comparison results outputted by the second comparison unit.

12. The image processing apparatus according to claim 7, wherein relative coordinates of N pixels in the coordinate information are arranged with respect to a square region, centered on the predetermined coordinates, whose sides are each K pixels (where, K is a positive integer that satisfies N<K²).

13. The image processing apparatus according to claim 5, wherein the storage unit holds the coordinate information as a table.

14. The image processing apparatus according to claim 2, further comprising a storage unit configured to store a pixel value of each pixel in the input image,
wherein the comparison unit reads pixel values of pixels necessary for the M comparison processes from the storage unit, and
a total number of reads of pixel values from the storage unit in the M comparison processes is a number smaller than 2M.

15. The image processing apparatus according to claim 5, further comprising a storage unit configured to store a pixel value of each pixel in the input image,
wherein the comparison unit calculates an address of at least one pixel to be a target of an n-th comparison process based on the coordinate information and a pixel position of the pixel of interest, and reads a pixel value at the calculated address in the storage unit.

16. The image processing apparatus according to claim 6, further comprising a storage unit configured to store a pixel value of each pixel in the input image,
wherein the comparison unit reads pixel values from the storage unit M+1 times in order to perform the M comparison processes.

17. A method of controlling an image processing apparatus operable to derive a feature amount of at least one pixel in an input image, the method comprising:
executing a comparison process for comparing pixel values of two pixels included in the input image and in a vicinity of a pixel of interest in the input image;
deriving a feature amount of the pixel of interest based on a result of a plurality of comparison processes by the comparing,
wherein at least one of target pixels of the comparison processing by the comparing is used in two or more comparison processes.

18. The method according to claim 17, wherein the comparing executes the comparison process of the pixel values of two pixels M times to output M comparison results, and wherein the two pixels compared at an n-th time (2≤n≤M) includes one of the two pixels compared at an (n−1)-th time.

19. A non-transitory computer-readable recording medium storing a program that causes a computer to function as an image processing apparatus operable to derive a feature amount of at least one pixel in an input image, the apparatus comprising:
a comparison unit configured to execute a comparison process for comparing pixel values of two pixels included in the input image in the vicinity of a pixel of interest in the input image; and
a derivation unit configured to derive a feature amount of the pixel of interest based on a result of a plurality of comparison processes by the comparison unit,
wherein at least one of target pixels of the comparison processing by the comparison unit is used in two or more comparison processes.
